(19) United States
(12) Patent Application Publication
(10) Pub. No.: US 2026/0079340 A1
(43) Pub. Date: Mar. 19, 2026

(54) Display System and Light Control Element Therefor

(71) Applicant: Envisics Ltd, Milton Keynes (GB)

(72) Inventor: Celedonia Krawczyk, Milton Keynes (GB)

(21) Appl. No.: 19/109,059

(22) PCT Filed: Sep. 4, 2023
(86) PCT No.: PCT/EP2023/074149

§ 371 Date: Mar. 5, 2025

(30) Foreign Application Priority Data
Sep. 5, 2022 (GB) 2212944.9

(51) Int. Cl. G02B 27/00; F21V 8/00; G02B 5/00; G02B 5/02; G02B 27/01

(52) U.S. Cl. CPC G02B 27/0081; G02B 5/003; G02B 5/0294; G02B 6/0055; G02B 27/0103; G02B 2027/0125; G02B 2207/123

(57) ABSTRACT

A display system and a waveguide pupil expander are described. The display system comprises an optical component having first and second major surfaces and one or more minor surfaces each defining an edge face of the optical component. One or more of the first and second major surfaces of the optical component are reflective. A light control layer is disposed over the first major surface of the optical component. The light control layer comprises a louvre structure comprising an array of louvres arranged to suppress reflections of sunlight received on an optical path to the first major surface. At least one edge face of the optical component is arranged to suppress specular reflection of light incident thereon. In embodiments, the optical component is a waveguide pupil expander.

### FIELD

The present disclosure relates to a display system. More specifically, the present disclosure relates to a display system comprising a waveguide pupil expander and to a method of pupil expansion using a waveguide. The present disclosure further relates to the suppression of reflections of sunlight and other stray light associated with an optical component of a display system. In some embodiments, the optical component comprises a waveguide pupil expander including a light control element. Some embodiments relate to a picture generating unit and a head-up display, for example an automotive head-up display (HUD).

### BACKGROUND AND INTRODUCTION

Light scattered from an object contains both amplitude and phase information. This amplitude and phase information can be captured on, for example, a photosensitive plate by well-known interference techniques to form a holographic recording, or “hologram”, comprising interference fringes. The hologram may be reconstructed by illumination with suitable light to form a two-dimensional or three-dimensional holographic reconstruction, or replay image, representative of the original object.

Computer-generated holography may numerically simulate the interference process. A computer-generated hologram may be calculated by a technique based on a mathematical transformation such as a Fresnel or Fourier transform. These types of holograms may be referred to as Fresnel/Fourier transform holograms or simply Fresnel/Fourier holograms. A Fourier hologram may be considered a Fourier domain/plane representation of the object or a frequency domain/plane representation of the object. A computer-generated hologram may also be calculated by coherent ray tracing or a point cloud technique, for example.

A computer-generated hologram may be encoded on a spatial light modulator arranged to modulate the amplitude and/or phase of incident light. Light modulation may be achieved using electrically-addressable liquid crystals, optically-addressable liquid crystals or micro-mirrors, for example.

A spatial light modulator typically comprises a plurality of individually-addressable pixels which may also be referred to as cells or elements. The light modulation scheme may be binary, multilevel or continuous. Alternatively, the device may be continuous (i.e. is not comprised of pixels) and light modulation may therefore be continuous across the device. The spatial light modulator may be reflective meaning that modulated light is output in reflection. The spatial light modulator may equally be transmissive meaning that modulated light is output in transmission.

A holographic projector may be provided using the system described herein. Such projectors have found application in head-up displays, “HUD”.

### SUMMARY

Aspects of the present disclosure are defined in the appended independent claims.

There is provided a display system comprising an optical component having first and second major surfaces and one or more minor surfaces. It may be said that each minor surface forms an edge or edge face of the optical component. One or more of the first and second major surfaces are reflective. A light control layer is disposed over the first major surface of the optical component. The light control layer comprises a louvre structure. The louvre structure comprises an array of louvres arranged to supress reflections of sunlight received on an optical path to the first major surface. At least one edge/edge face of the optical component is arranged to suppress specular reflection of light incident thereon.

In some embodiments, the at least one edge face of the optical component is arranged to attenuate and/or diffusely reflect/scatter light incident thereon. For instance, the at least one edge face may include a material, element or component that attenuates and/or diffusely reflects or scatters light. Thus, light directly or indirectly incident on the at least one edge face is diffusely reflected/scattered and/or attenuated so as to supress reflections of light. The skilled person will understand that a surface that diffusely reflects/scatters light also attenuates light. However, other techniques for attenuation of incident light are possible and contemplated.

In other embodiments, the at least one edge face of the optical component is arranged to absorb light incident thereon. For instance, the at least one edge face of the optical component may comprise a light absorbing material or include a light absorbing element or component. In examples, the at least one edge face is coated with a light absorbing coating, such as a black coating. Thus, light directly or indirectly incident on the at least one edge face is absorbed so as to supress reflections of light.

In examples, the at least one edge face of the optical component is coated with a light attenuating coating, such as an opaque coating, or the at least one edge of the optical component is treated, such as by etching, so as to attenuate and/or diffusely reflect/scatter light incident thereon.

In other examples, the at least one edge face of the optical component includes a border, wherein the border is arranged to diffusely reflect/scatter and/or attenuate light incident thereon. For example, the border may comprise a sheet material having diffuse light reflecting/scattering properties or may comprise a sheet material comprising a coating or film having diffuse light reflecting/scattering properties.

In some embodiments, the first major surface of the optical component comprises an exit surface for the output of image light of the display system to a viewing area. The optical component may comprise a light turning element for controlling the direction of the output image light from the exit surface. In some embodiments, the light turning element comprises a first major surface and one or more minor surfaces each defining forming an edge face thereof. The first major surface of the light turning element may form an interface with the exit surface of the optical component. At least one edge face of the light turning element may be arranged to suppress specular reflection of light incident thereon. In some examples, the light turning element is a light turning film such as a film comprising an array of prisms having inclined surfaces opposite the first major surface. In some embodiment, the at least one edge of the light turning element is arranged to absorb light incident thereon or to attenuate or diffusely reflect/scatter light incident thereon.

In some embodiments, the display system comprises an opaque border or box surrounding the one or more minor surfaces forming edges faces of the optical component. The opaque border or box further serves to supress specular reflections of light, for example by blocking, attenuating and/or diffusely reflecting/scattering light directly incident on the edge faces of the optical component.

In embodiments of the display system, the optical component comprises a waveguide pupil expander. In examples, the first and second major surfaces are opposed/parallel reflective surfaces arranged to provide internal reflection and waveguiding of image light therebetween. For example, the first major surface comprises a partially reflective-partially transmissive surface forming an exit surface of the waveguide pupil expander. In examples, the at least one edge face arranged to suppress specular reflection of light incident thereon comprises an edge face at a first end of the waveguide pupil expander, wherein pupil expansion is from the first end to a second end of the waveguide pupil expander.

There is further provided a waveguide pupil expander for the display system.

In embodiments, the optical component is a waveguide pupil expander. The light control layer is disposed on the exit surface of the waveguide pupil expander forming the output port for image light from the display system towards the viewing area thereof. For example, the waveguide pupil expander may comprise a pair of parallel reflective surfaces arranged for internal reflection and waveguiding of image light of the display system. The pair of parallel reflective surfaces comprises a first fully reflective surface and a second partially reflective-partially transmissive surface forming the exit surface. The exit surface may be the planar surface, the reflective surface of the optical component or both.

In the present disclosure, the term “replica” is merely used to reflect that spatially modulated light is divided such that a complex light field is directed along a plurality of different optical paths. The word “replica” is used to refer to each occurrence or instance of the complex light field after a replication event—such as a partial reflection-transmission by a pupil expander. Each replica travels along a different optical path. Some embodiments of the present disclosure relate to propagation of light that is encoded with a hologram, not an image—i.e., light that is spatially modulated with a hologram of an image, not the image itself. It may therefore be said that a plurality of replicas of the hologram are formed. The person skilled in the art of holography will appreciate that the complex light field associated with propagation of light encoded with a hologram will change with propagation distance. Use herein of the term “replica” is independent of propagation distance and so the two branches or paths of light associated with a replication event are still referred to as “replicas” of each other even if the branches are a different length, such that the complex light field has evolved differently along each path. That is, two complex light fields are still considered “replicas” in accordance with this disclosure even if they are associated with different propagation distances—providing they have arisen from the same replication event or series of replication events.

A “diffracted light field” or “diffractive light field” in accordance with this disclosure is a light field formed by diffraction. A diffracted light field may be formed by illuminating a corresponding diffractive pattern. In accordance with this disclosure, an example of a diffractive pattern is a hologram and an example of a diffracted light field is a holographic light field or a light field forming a holographic reconstruction of an image. The holographic light field forms a (holographic) reconstruction of an image on a replay plane. The holographic light field that propagates from the hologram to the replay plane may be said to comprise light encoded with the hologram or light in the hologram domain. A diffracted light field is characterized by a diffraction angle determined by the smallest feature size of the diffractive structure and the wavelength of the light (of the diffracted light field). In accordance with this disclosure, it may also be said that a “diffracted light field” is a light field that forms a reconstruction on a plane spatially separated from the corresponding diffractive structure. An optical system is disclosed herein for propagating a diffracted light field from a diffractive structure to a viewer. The diffracted light field may form an image. The term “hologram” is used to refer to the recording which contains amplitude information or phase information, or some combination thereof, regarding the object. The term “holographic reconstruction” is used to refer to the optical reconstruction of the object which is formed by illuminating the hologram. The system disclosed herein is described as a “holographic projector” because the holographic reconstruction is a real image and spatially-separated from the hologram. The term “replay field” is used to refer to the 2D area within which the holographic reconstruction is formed and fully focused. If the hologram is displayed on a spatial light modulator comprising pixels, the replay field will be repeated in the form of a plurality diffracted orders wherein each diffracted order is a replica of the zeroth-order replay field. The zeroth-order replay field generally corresponds to the preferred or primary replay field because it is the brightest replay field. Unless explicitly stated otherwise, the term “replay field” should be taken as referring to the zeroth-order replay field. The term “replay plane” is used to refer to the plane in space containing all the replay fields. The terms “image”, “replay image” and “image region” refer to areas of the replay field illuminated by light of the holographic reconstruction. In some embodiments, the “image” may comprise discrete spots which may be referred to as “image spots”or, for convenience only, “image pixels”.

The terms “encoding”, “writing” or “addressing” are used to describe the process of providing the plurality of pixels of the SLM with a respective plurality of control values which respectively determine the modulation level of each pixel. It may be said that the pixels of the SLM are configured to “display” a light modulation distribution in response to receiving the plurality of control values. Thus, the SLM may be said to “display” a hologram and the hologram may be considered an array of light modulation values or levels.

It has been found that a holographic reconstruction of acceptable quality can be formed from a “hologram” containing only phase information related to the Fourier transform of the original object. Such a holographic recording may be referred to as a phase-only hologram. Embodiments relate to a phase-only hologram but the present disclosure is equally applicable to amplitude-only holography.

The present disclosure is also equally applicable to forming a holographic reconstruction using amplitude and phase information related to the Fourier transform of the original object. In some embodiments, this is achieved by complex modulation using a so-called fully complex hologram which contains both amplitude and phase information related to the original object. Such a hologram may be referred to as a fully-complex hologram because the value (grey level) assigned to each pixel of the hologram has an amplitude and phase component. The value (grey level) assigned to each pixel may be represented as a complex number having both amplitude and phase components. In some embodiments, a fully-complex computer-generated hologram is calculated.

Reference may be made to the phase value, phase component, phase information or, simply, phase of pixels of the computer-generated hologram or the spatial light modulator as shorthand for “phase-delay”. That is, any phase value described is, in fact, a number (e.g. in the range 0 to 2π) which represents the amount of phase retardation provided by that pixel. For example, a pixel of the spatial light modulator described as having a phase value of π/2 will retard the phase of received light by π/2 radians. In some embodiments, each pixel of the spatial light modulator is operable in one of a plurality of possible modulation values (e.g. phase delay values). The term “grey level” may be used to refer to the plurality of available modulation levels. For example, the term “grey level” may be used for convenience to refer to the plurality of available phase levels in a phase-only modulator even though different phase levels do not provide different shades of grey. The term “grey level” may also be used for convenience to refer to the plurality of available complex modulation levels in a complex modulator.

The hologram therefore comprises an array of grey levels—that is, an array of light modulation values such as an array of phase-delay values or complex modulation values. The hologram is also considered a diffractive pattern because it is a pattern that causes diffraction when displayed on a spatial light modulator and illuminated with light having a wavelength comparable to, generally less than, the pixel pitch of the spatial light modulator. Reference is made herein to combining the hologram with other diffractive patterns such as diffractive patterns functioning as a lens or grating. For example, a diffractive pattern functioning as a grating may be combined with a hologram to translate the replay field on the replay plane or a diffractive pattern functioning as a lens may be combined with a hologram to focus the holographic reconstruction on a replay plane in the near field.

Although different embodiments and groups of embodiments may be disclosed separately in the detailed description which follows, any feature of any embodiment or group of embodiments may be combined with any other feature or combination of features of any embodiment or group of embodiments. That is, all possible combinations and permutations of features disclosed in the present disclosure are envisaged.

### BRIEF DESCRIPTION OF THE DRAWINGS

Specific embodiments are described by way of example only with reference to the following figures:

FIG. 1 is a schematic showing a reflective SLM producing a holographic reconstruction on a screen;

FIG. 2 shows an image for projection comprising eight image areas/components, V1 to V8, and cross-sections of the corresponding hologram channels, H1-H8;

FIG. 3 shows a hologram displayed on an LCOS that directs light into a plurality of discrete areas;

FIG. 4 shows a system, including a display device that displays a hologram that has been calculated as illustrated in FIGS. 2 and 3;

FIG. 5 shows a perspective view of a first example two-dimensional pupil expander comprising two replicators;

FIGS. 6A and 6B are schematic views of an automotive head-up display system showing potential areas of sunlight glare;

FIG. 7 is a schematic view of a light control layer formed on a transmission surface of a pupil expander of an automotive head-up display system;

FIG. 8 is a polar plot showing simulations of sunlight glare, from different sun elevation angles, at the centre of the viewing area of an automotive head-up display comprising a waveguide pupil expander in accordance with a comparative example;

FIG. 9 is polar plot, equivalent to FIG. 8, showing simulations of sunlight glare, from different sun elevation angles, at the centre of the viewing area of an automotive head-up display comprising a waveguide pupil expander with reflection suppression in accordance with an embodiment;

FIG. 10 is a schematic diagram of a waveguide pupil expander of a display system showing example rays of sunlight that may be received and reflected towards a viewing area, and FIGS. 11A and 11B are schematic diagrams of the waveguide pupil expander of FIG. 10, with reflection suppression in accordance with embodiments of the present disclosure.

The same reference numbers will be used throughout the drawings to refer to the same or like parts.

### DETAILED DESCRIPTION OF EMBODIMENTS

The present invention is not restricted to the embodiments described in the following but extends to the full scope of the appended claims. That is, the present invention may be embodied in different forms and should not be construed as limited to the described embodiments, which are set out for the purpose of illustration.

Terms of a singular form may include plural forms unless specified otherwise.

A structure described as being formed at an upper portion/lower portion of another structure or on/under the other structure should be construed as including a case where the structures contact each other and, moreover, a case where a third structure is disposed there between.

An optical component may comprise major surfaces and minor surfaces. For example, in the case of a (bulk optic) waveguide pupil expander, the longitudinally extending first and second parallel reflective surfaces for waveguiding light therebetween form the major surfaces, and the other surfaces—the edge faces at the side walls and end walls thereof—form the minor surfaces and typically are in a plane orthogonal to the plane of the major surfaces.

In describing a time relationship-for example, when the temporal order of events is described as “after”, “subsequent”, “next”, “before” or suchlike—the present disclosure should be taken to include continuous and non-continuous events unless otherwise specified. For example, the description should be taken to include a case which is not continuous unless wording such as “just”, “immediate”or “direct”is used.

Although the terms “first”, “second”, etc. may be used herein to describe various elements, these elements are not to be limited by these terms. These terms are only used to distinguish one element from another. For example, a first element could be termed a second element, and, similarly, a second element could be termed a first element, without departing from the scope of the appended claims.

Features of different embodiments may be partially or overall coupled to or combined with each other, and may be variously inter-operated with each other. Some embodiments may be carried out independently from each other, or may be carried out together in co-dependent relationship.

In the present disclosure, the term “substantially” when applied to a structural units of an apparatus may be interpreted as the technical feature of the structural units being produced within the technical tolerance of the method used to manufacture it.

### Conventional Optical Configuration for Holographic Projection

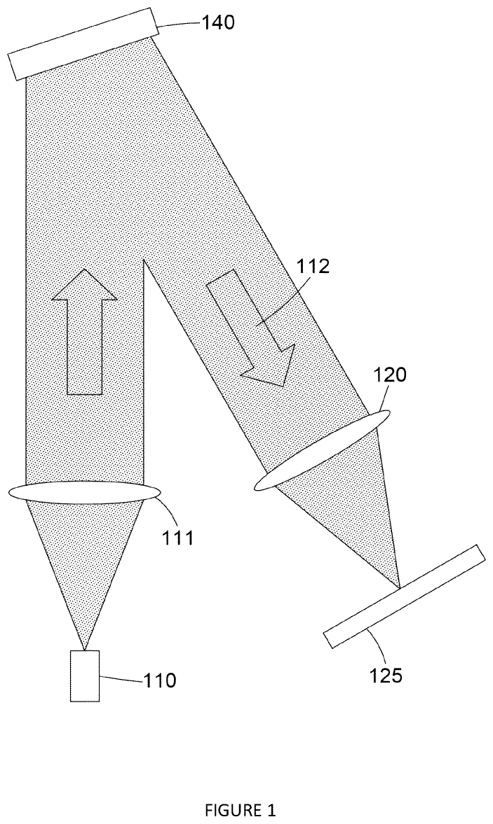

FIG. 1 shows an embodiment in which a computer-generated hologram is encoded on a single spatial light modulator. The computer-generated hologram is a Fourier transform of the object for reconstruction. It may therefore be said that the hologram is a Fourier domain or frequency domain or spectral domain representation of the object. In this embodiment, the spatial light modulator is a reflective liquid crystal on silicon, “LCOS”, device. The hologram is encoded on the spatial light modulator and a holographic reconstruction is formed at a replay field, for example, a light receiving surface such as a screen or diffuser.

A light source 110, for example a laser or laser diode, is disposed to illuminate the SLM 140 via a collimating lens 111. The collimating lens causes a generally planar wavefront of light to be incident on the SLM. In FIG. 1, the direction of the wavefront is off-normal (e.g. two or three degrees away from being truly orthogonal to the plane of the transparent layer). However, in other embodiments, the generally planar wavefront is provided at normal incidence and a beam splitter arrangement is used to separate the input and output optical paths. In the embodiment shown in FIG. 1, the arrangement is such that light from the light source is reflected off a mirrored rear surface of the SLM and interacts with a light-modulating layer to form an exit wavefront 112. The exit wavefront 112 is applied to optics including a Fourier transform lens 120, having its focus at a screen 125. More specifically, the Fourier transform lens 120 receives a beam of modulated light from the SLM 140 and performs a frequency-space transformation to produce a holographic reconstruction at the screen 125.

Notably, in this type of holography, each pixel of the hologram contributes to the whole reconstruction. There is not a one-to-one correlation between specific points (or image pixels) on the replay field and specific light-modulating elements (or hologram pixels). In other words, modulated light exiting the light-modulating layer is distributed across the replay field.

In these embodiments, the position of the holographic reconstruction in space is determined by the dioptric (focusing) power of the Fourier transform lens. In the embodiment shown in FIG. 1, the Fourier transform lens is a physical lens. That is, the Fourier transform lens is an optical Fourier transform lens and the Fourier transform is performed optically. Any lens can act as a Fourier transform lens but the performance of the lens will limit the accuracy of the Fourier transform it performs. The skilled person understands how to use a lens to perform an optical Fourier transform. In some embodiments of the present disclosure, the lens of the viewer's eye performs the hologram to image transformation.

### Hologram Calculation

In some embodiments, the computer-generated hologram is a Fourier transform hologram, or simply a Fourier hologram or Fourier-based hologram, in which an image is reconstructed in the far field by utilising the Fourier transforming properties of a positive lens. The Fourier hologram is calculated by Fourier transforming the desired light field in the replay plane back to the lens plane. Computer-generated Fourier holograms may be calculated using Fourier transforms. Embodiments relate to Fourier holography and Gerchberg-Saxton type algorithms by way of example only. The present disclosure is equally applicable to Fresnel holography and Fresnel holograms which may be calculated by a similar method. In some embodiments, the hologram is a phase or phase-only hologram. However, the present disclosure is also applicable to holograms calculated by other techniques such as those based on point cloud methods.

In some embodiments, the hologram engine is arranged to exclude from the hologram calculation the contribution of light blocked by a limiting aperture of the display system. British patent application 2101666.2, filed 5 Feb. 2021 and incorporated herein by reference, discloses a first hologram calculation method in which eye-tracking and ray tracing are used to identify a sub-area of the display device for calculation of a point cloud hologram which eliminates ghost images. The sub-area of the display device corresponds with the aperture of the present disclosure, and is used exclude light paths from the hologram calculation. British patent application 2112213.0, filed 26 Aug. 2021 and incorporated herein by reference, discloses a second method based on a modified Gerchberg-Saxton type algorithm which includes steps of light field cropping in accordance with pupils of the optical system during hologram calculation. The cropping of the light field corresponds with the determination of a limiting aperture of the present disclosure. British patent application 2118911.3, filed 23 Dec. 2021 and also incorporated herein by reference, discloses a third method of calculating a hologram which includes a step of determining a region of a so-called extended modulator formed by a hologram replicator. The region of the extended modulator is also an aperture in accordance with this disclosure.

In some embodiments, there is provided a real-time engine arranged to receive image data and calculate holograms in real-time using the algorithm. In some embodiments, the image data is a video comprising a sequence of image frames. In other embodiments, the holograms are pre-calculated, stored in computer memory and recalled as needed for display on a SLM. That is, in some embodiments, there is provided a repository of predetermined holograms.

### Large Field of View and/or Eye-box Using Small Display Device

Broadly, the present disclosure relates to image projection. It relates to a method of image projection and an image projector which comprises a display device. The present disclosure also relates to a projection system comprising the image projector and a viewing system, in which the image projector projects or relays light from the display device to the viewing system. The present disclosure is equally applicable to a monocular and binocular viewing system. The viewing system may comprise a viewer's eye or eyes. The viewing system comprises an optical element having optical power (e.g., lens/es of the human eye) and a viewing plane (e.g., retina of the human eye/s). The projector may be referred to as a ‘light engine’. The display device and the image formed (or perceived) using the display device are spatially separated from one another. The image is formed, or perceived by a viewer, on a display plane. In some embodiments, the image is a virtual image and the display plane may be referred to as a virtual image plane. In other examples, the image is a real image formed by holographic reconstruction and the image is projected or relayed to the viewing plane. In these other examples, spatially modulated light of an intermediate holographic reconstruction formed either in free space or on a screen or other light receiving surface between the display device and the viewer, is propagated to the viewer. In both cases, an image is formed by illuminating a diffractive pattern (e.g., hologram or kinoform) displayed on the display device.

The display device comprises pixels. The pixels of the display may display a diffractive pattern or structure that diffracts light. The diffracted light may form an image at a plane spatially separated from the display device. In accordance with well-understood optics, the magnitude of the maximum diffraction angle is determined by the size of the pixels and other factors such as the wavelength of the light.

In embodiments, the display device is a spatial light modulator such as liquid crystal on silicon (“LCOS”) spatial light modulator (SLM). Light propagates over a range of diffraction angles (for example, from zero to the maximum diffractive angle) from the LCOS, towards a viewing entity/system such as a camera or an eye. In some embodiments, magnification techniques may be used to increase the range of available diffraction angles beyond the conventional maximum diffraction angle of an LCOS.

In some embodiments, the (light of a) hologram itself is propagated to the eyes. For example, spatially modulated light of the hologram (that has not yet been fully transformed to a holographic reconstruction, i.e. image)—that may be informally said to be “encoded” with/by the hologram—is propagated directly to the viewer's eyes. A real or virtual image may be perceived by the viewer. In these embodiments, there is no intermediate holographic reconstruction/image formed between the display device and the viewer. It is sometimes said that, in these embodiments, the lens of the eye performs a hologram-to-image conversion or transform. The projection system, or light engine, may be configured so that the viewer effectively looks directly at the display device.

Reference is made herein to a “light field” which is a “complex light field”. The term “light field” merely indicates a pattern of light having a finite size in at least two orthogonal spatial directions, e.g. x and y. The word “complex” is used herein merely to indicate that the light at each point in the light field may be defined by an amplitude value and a phase value, and may therefore be represented by a complex number or a pair of values. For the purpose of hologram calculation, the complex light field may be a two-dimensional array of complex numbers, wherein the complex numbers define the light intensity and phase at a plurality of discrete locations within the light field.

In accordance with the principles of well-understood optics, the range of angles of light propagating from a display device that can be viewed, by an eye or other viewing entity/system, varies with the distance between the display device and the viewing entity. At a 1 metre viewing distance, for example, only a small range of angles from an LCOS can propagate through an eye's pupil to form an image at the retina for a given eye position. The range of angles of light rays that are propagated from the display device, which can successfully propagate through an eye's pupil to form an image at the retina for a given eye position, determines the portion of the image that is ‘visible’ to the viewer. In other words, not all parts of the image are visible from any one point on the viewing plane (e.g., any one eye position within a viewing window such as an eye-box.)

In some embodiments, the image perceived by a viewer is a virtual image that appears upstream of the display device—that is, the viewer perceives the image as being further away from them than the display device. Conceptually, it may therefore be considered that the viewer is looking at a virtual image through an ‘display device-sized window’, which may be very small, for example 1 cm in diameter, at a relatively large distance, e.g., 1 metre. And the user will be viewing the display device-sized window via the pupil(s) of their eye(s), which can also be very small. Accordingly, the field of view becomes small and the specific angular range that can be seen depends heavily on the eye position, at any given time.

A pupil expander addresses the problem of how to increase the range of angles of light rays that are propagated from the display device that can successfully propagate through an eye's pupil to form an image. The display device is generally (in relative terms) small and the projection distance is (in relative terms) large. In some embodiments, the projection distance is at least one—such as, at least two-orders of magnitude greater than the diameter, or width, of the entrance pupil and/or aperture of the display device (i.e., size of the array of pixels).

Use of a pupil expander increases the viewing area (i.e., user's eye-box) laterally, thus enabling some movement of the eye/s to occur, whilst still enabling the user to see the image. As the skilled person will appreciate, in an imaging system, the viewing area (user's eye box) is the area in which a viewer's eyes can perceive the image. The present disclosure encompasses non-infinite virtual image distances—that is, near-field virtual images.

Conventionally, a two-dimensional pupil expander comprises one or more one-dimensional optical waveguides each formed using a pair of opposing reflective surfaces, in which the output light from a surface forms a viewing window or eye-box. Light received from the display device (e.g., spatially modulated light from a LCOS) is replicated by the or each waveguide so as to increase the field of view (or viewing area) in at least one dimension. In particular, the waveguide enlarges the viewing window due to the generation of extra rays or “replicas” by division of amplitude of the incident wavefront.

The display device may have an active or display area having a first dimension that may be less than 10 cms such as less than 5 cms or less than 2 cms. The propagation distance between the display device and viewing system may be greater than 1 m such as greater than 1.5 m or greater than 2 m. The optical propagation distance within the waveguide may be up to 2 m such as up to 1.5 m or up to 1 m. The method may be capable of receiving an image and determining a corresponding hologram of sufficient quality in less than 20 ms such as less than 15 ms or less than 10 ms.

In some embodiments-described only by way of example of a diffracted or holographic light field in accordance with this disclosure—a hologram is configured to route light into a plurality of channels, each channel corresponding to a different part (i.e. sub-area) of an image. The channels formed by the diffractive structure are referred to herein as “hologram channels” merely to reflect that they are channels of light encoded by the hologram with image information. It may be said that the light of each channel is in the hologram domain rather than the image or spatial domain. In some embodiments, the hologram is a Fourier or Fourier transform hologram and the hologram domain is therefore the Fourier or frequency domain. The hologram may equally be a Fresnel or Fresnel transform hologram. The hologram may also be a point cloud hologram. The hologram is described herein as routing light into a plurality of hologram channels to reflect that the image that can be reconstructed from the hologram has a finite size and can be arbitrarily divided into a plurality of image sub-areas, wherein each hologram channel would correspond to each image sub-area. Importantly, the hologram of this example is characterised by how it distributes the image content when illuminated. Specifically and uniquely, the hologram divides the image content by angle. That is, each point on the image is associated with a unique light ray angle in the spatially modulated light formed by the hologram when illuminated—at least, a unique pair of angles because the hologram is two-dimensional. For the avoidance of doubt, this hologram behaviour is not conventional. The spatially modulated light formed by this special type of hologram, when illuminated, may be divided into a plurality of hologram channels, wherein each hologram channel is defined by a range of light ray angles (in two-dimensions). It will be understood from the foregoing that any hologram channel (i.e. sub-range of light ray angles) that may be considered in the spatially modulated light will be associated with a respective part or sub-area of the image. That is, all the information needed to reconstruct that part or sub-area of the image is contained within a sub-range of angles of the spatially modulated light formed from the hologram of the image. When the spatially modulated light is observed as a whole, there is not necessarily any evidence of a plurality of discrete light channels.

Nevertheless, the hologram may still be identified. For example, if only a continuous part or sub-area of the spatially modulated light formed by the hologram is reconstructed, only a sub-area of the image should be visible. If a different, continuous part or sub-area of the spatially modulated light is reconstructed, a different sub-area of the image should be visible. A further identifying feature of this type of hologram is that the shape of the cross-sectional area of any hologram channel substantially corresponds to (i.e. is substantially the same as) the shape of the entrance pupil although the size may be different—at least, at the correct plane for which the hologram was calculated. Each light/hologram channel propagates from the hologram at a different angle or range of angles. Whilst these are example ways of characterising or identifying this type of hologram, other ways may be used. In summary, the hologram disclosed herein is characterised and identifiable by how the image content is distributed within light encoded by the hologram. Again, for the avoidance of any doubt, reference herein to a hologram configured to direct light or angularly-divide an image into a plurality of hologram channels is made by way of example only and the present disclosure is equally applicable to pupil expansion of any type of holographic light field or even any type of diffractive or diffracted light field.

The system can be provided in a compact and streamlined physical form. This enables the system to be suitable for a broad range of real-world applications, including those for which space is limited and real-estate value is high. For example, it may be implemented in a head-up display (HUD) such as a vehicle or automotive HUD.

In accordance with the present disclosure, pupil expansion is provided for diffracted or diffractive light, which may comprise diverging ray bundles. The diffracted light field may be defined by a “light cone”. Thus, the size of the diffracted light field (as defined on a two-dimensional plane) increases with propagation distance from the corresponding diffractive structure (i.e. display device). It can be said that the pupil expander/s replicate the hologram or form at least one replica of the hologram, to convey that the light delivered to the viewer is spatially modulated in accordance with a hologram.

In some embodiments, two one-dimensional waveguide pupil expanders are provided, each one-dimensional waveguide pupil expander being arranged to effectively increase the size of the exit pupil of the system by forming a plurality of replicas or copies of the exit pupil (or light of the exit pupil) of the spatial light modulator. The exit pupil may be understood to be the physical area from which light is output by the system. It may also be said that each waveguide pupil expander is arranged to expand the size of the exit pupil of the system. It may also be said that each waveguide pupil expander is arranged to expand/increase the size of the eye box within which a viewer's eye can be located, in order to see/receive light that is output by the system.

### Light Channelling in the Hologram Domain

The hologram formed in accordance with some embodiments, angularly-divides the image content to provide a plurality of hologram channels which may have a cross-sectional shape defined by an aperture of the optical system. The hologram is calculated to provide this channelling of the diffracted light field. In some embodiments, this is achieved during hologram calculation by considering an aperture (virtual or real) of the optical system, as described above.

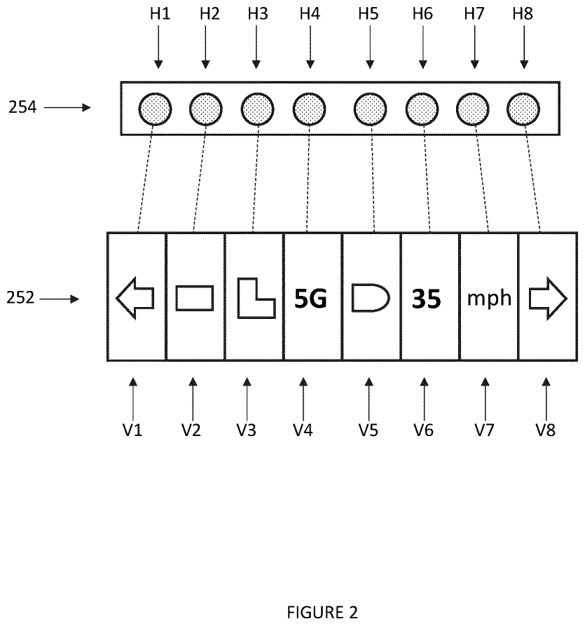

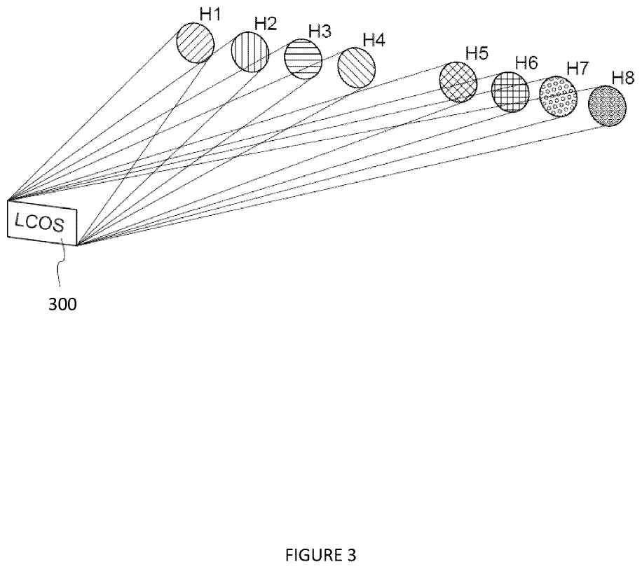

FIGS. 2 and 3 show an example of this type of hologram that may be used in conjunction with a pupil expander as disclosed herein. However, this example should not be regarded as limiting with respect to the present disclosure.

FIG. 2 shows an image 252 for projection comprising eight image areas/components, V1 to V8. FIG. 2 shows eight image components by way of example only and the image 252 may be divided into any number of components. FIG. 2 also shows an encoded light pattern 254 (i.e., hologram) that can reconstruct the image 252—e.g., when transformed by the lens of a suitable viewing system. The encoded light pattern 254 comprises first to eighth sub-holograms or components, H1 to H8, corresponding to the first to eighth image components/areas, V1 to V8. FIG. 2 further shows how a hologram may decompose the image content by angle. The hologram may therefore be characterised by the channelling of light that it performs. This is illustrated in FIG. 3. Specifically, the hologram in this example directs light into a plurality of discrete areas. The discrete areas are discs in the example shown but other shapes are envisaged. The size and shape of the optimum disc may, after propagation through the waveguide, be related to the size and shape of an aperture of the optical system such as the entrance pupil of the viewing system.

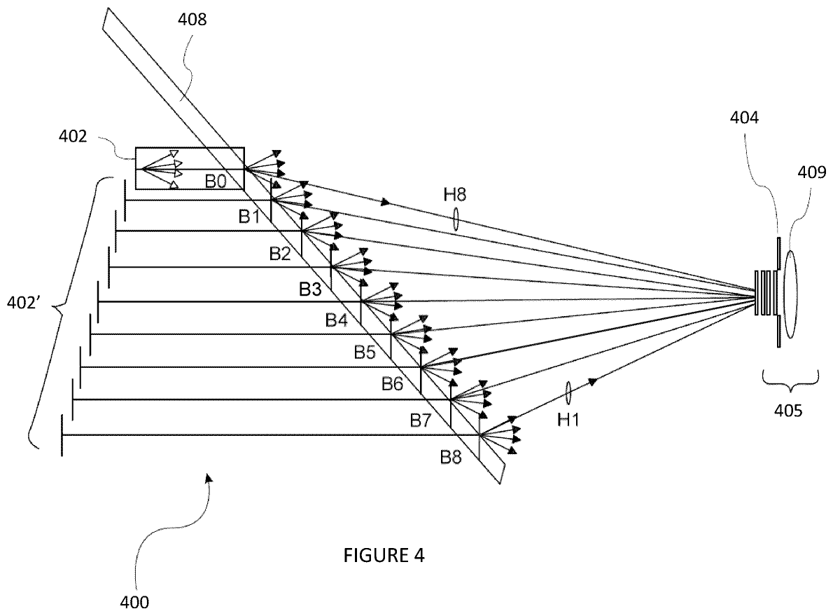

FIG. 4 shows a system 400, including a display device that displays a hologram that has been calculated as illustrated in FIGS. 2 and 3.

The system 400 comprises a display device, which in this arrangement comprises an LCOS 402. The LCOS 402 is arranged to display a modulation pattern (or ‘diffractive pattern’) comprising the hologram and to project light that has been holographically encoded towards an eye 405 that comprises a pupil that acts as an aperture 404, a lens 409, and a retina (not shown) that acts as a viewing plane. There is a light source (not shown) arranged to illuminate the LCOS 402. The lens 409 of the eye 405 performs a hologram-to-image transformation. The light source may be of any suitable type. For example, it may comprise a laser light source.

The viewing system 400 further comprises a waveguide 408 positioned between the LCOS 402 and the eye 405. The presence of the waveguide 408 enables all angular content from the LCOS 402 to be received by the eye, even at the relatively large projection distance shown. This is because the waveguide 508 acts as a pupil expander, in a manner that is well known and so is described only briefly herein.

In brief, the waveguide 408 shown in FIG. 4 comprises a substantially elongate formation. In this example, the waveguide 408 comprises an optical slab of refractive material, but other types of waveguide are also well known and may be used. The waveguide 408 is located so as to intersect the light cone (i.e., the diffracted light field) that is projected from the LCOS 402, for example at an oblique angle. In this example, the size, location, and position of the waveguide 408 are configured to ensure that light from each of the eight ray bundles, within the light cone, enters the waveguide 408. Light from the light cone enters the waveguide 408 via its first planar surface (located nearest the LCOS 402) and is guided at least partially along the length of the waveguide 408, before being emitted via its second planar surface, substantially opposite the first surface (located nearest the eye). As will be well understood, the second planar surface is partially reflective, partially transmissive. In other words, when each ray of light travels within the waveguide 408 from the first planar surface and hits the second planar surface, some of the light will be transmitted out of the waveguide 408 and some will be reflected by the second planar surface, back towards the first planar surface. The first planar surface is reflective, such that all light that hits it, from within the waveguide 408, will be reflected back towards the second planar surface. Therefore, some of the light may simply be refracted between the two planar surfaces of the waveguide 408 before being transmitted, whilst other light may be reflected, and thus may undergo one or more reflections, (or ‘bounces’) between the planar surfaces of the waveguide 408, before being transmitted.

FIG. 4 shows a total of nine “bounce” points, B0 to B8, along the length of the waveguide 408. Although light relating to all points of the image (V1-V8) as shown in FIG. 2 is transmitted out of the waveguide at each “bounce” from the second planar surface of the waveguide 408, only the light from one angular part of the image (e.g. light of one of V1 to V8) has a trajectory that enables it to reach the eye 405, from each respective “bounce” point, B0 to B8. Moreover, light from a different angular part of the image, V1 to V8, reaches the eye 405 from each respective “bounce” point. Therefore, each angular channel of encoded light reaches the eye only once, from the waveguide 408, in the example of FIG. 4.

Although virtual images, which require the eye to transform received modulated light in order to form a perceived image, have generally been discussed herein, the methods and arrangements described herein can be applied to real images.

### Two-dimensional Pupil Expansion

Whilst the arrangement shown in FIG. 4 includes a single waveguide that provides pupil expansion in one dimension, pupil expansion can be provided in more than one dimension, for example in two dimensions. Moreover, whilst the example in FIG. 4 uses a hologram that has been calculated to create channels of light, each corresponding to a different portion of an image, the present disclosure and the systems that are described herebelow are not limited to such a hologram type.

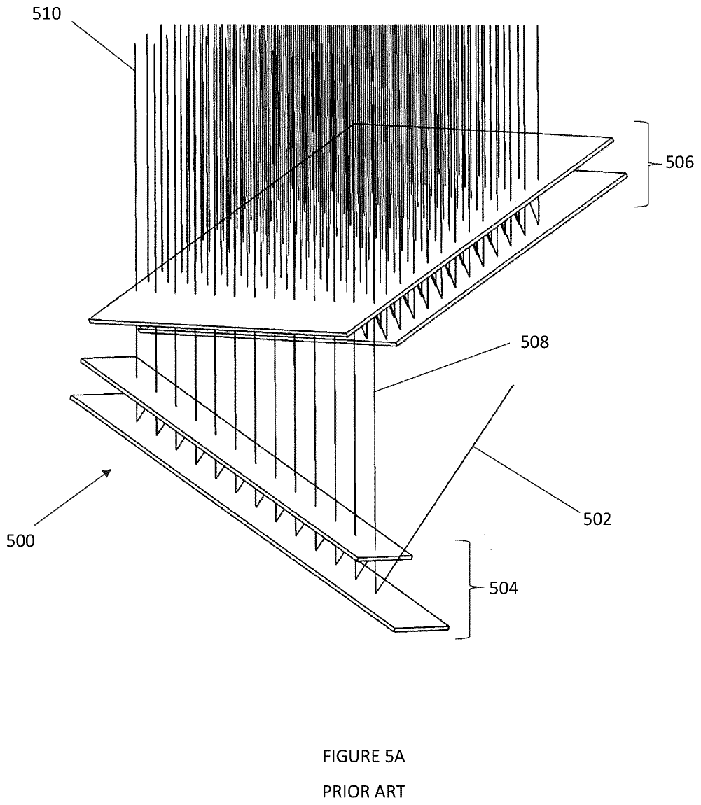

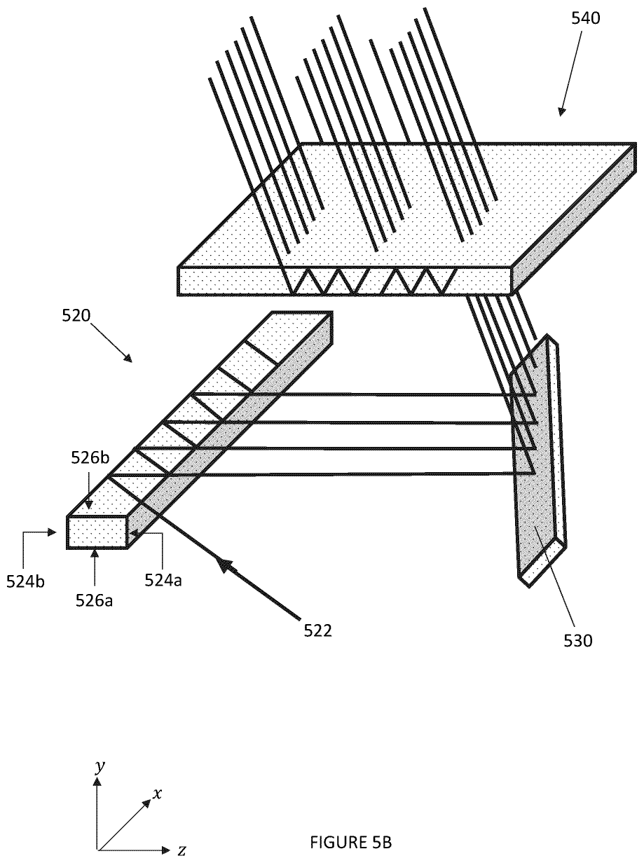

FIG. 5A shows a perspective view of a system 500 comprising two replicators, 504, 506 arranged for expanding a light beam 502 in two dimensions.

In the system 500 of FIG. 5A, the first replicator 504 comprises a first pair of surfaces, stacked parallel to one another, and arranged to provide replication- or, pupil expansion—in a similar manner to the waveguide 408 of FIG. 4. The first pair of surfaces are similarly (in some cases, identically) sized and shaped to one another and are substantially elongate in one direction. The collimated light beam 502 is directed towards an input on the first replicator 504. Due to a process of internal reflection between the two surfaces, and partial transmission of light from each of a plurality of output points on one of the surfaces (the upper surface, as shown in FIG. 5A), which will be familiar to the skilled reader, light of the light beam 502 is replicated in a first direction, along the length of the first replicator 504. Thus, a first plurality of replica light beams 508 is emitted from the first replicator 504, towards the second replicator 506.

The second replicator 506 comprises a second pair of surfaces stacked parallel to one another, arranged to receive each of the collimated light beams of the first plurality of light beams 508 and further arranged to provide replication- or, pupil expansion—by expanding each of those light beams in a second direction, substantially orthogonal to the first direction. The first pair of surfaces are similarly (in some cases, identically) sized and shaped to one another and are substantially rectangular. The rectangular shape is implemented for the second replicator in order for it to have length along the first direction, in order to receive the first plurality of light beams 508, and to have length along the second, orthogonal direction, in order to provide replication in that second direction. Due to a process of internal reflection between the two surfaces, and partial transmission of light from each of a plurality of output points on one of the surfaces (the upper surface, as shown in FIG. 5A), light of each light beam within the first plurality of light beams 508 is replicated in the second direction. Thus, a second plurality of light beams 510 is emitted from the second replicator 506, wherein the second plurality of light beams 510 comprises replicas of the input light beam 502 along each of the first direction and the second direction. Thus, the second plurality of light beams 510 may be regarded as comprising a two-dimensional grid, or array, of replica light beams.

Thus, it can be said that the first and second replicators 504, 505 of FIG. 5A combine to provide a two-dimensional replicator (or, “two-dimensional pupil expander”). Thus, the replica light beams 510 may be emitted along an optical path to an expanded eye-box of a display system, such as a head-up display.

In the system of FIG. 5A, the first replicator 504 is a waveguide comprising a pair of elongate rectilinear reflective surfaces, stacked parallel to one another, and, similarly, the second replicator 504 is a waveguide comprising a pair of rectangular reflective surfaces, stacked parallel to one another. In other systems, the first replicator may be a solid elongate rectilinear waveguide and the second replicator may be a solid planar rectangular shaped waveguide, wherein each waveguide comprises an optically transparent solid material such as glass. In this case, the pair of parallel reflective surfaces are formed by a pair of opposed major sidewalls optionally comprising respective reflective and reflective-transmissive surface coatings, familiar to the skilled reader.

FIG. 5B shows a perspective view of a system 500 comprising two replicators, 520, 540 arranged for replicating a light beam 522 in two dimensions, in which the first replicator is a solid elongated waveguide 520 and the second replicator is a solid planar waveguide 540.

In the system of FIG. 5B, the first replicator/waveguide 520 is arranged so that its pair of elongate parallel reflective surfaces 524a, 524b are perpendicular to the plane of the second replicator/waveguide 540. Accordingly, the system comprises an optical coupler arranged to couple light from an output port of first replicator 520 into an input port of the second replicator 540. In the illustrated arrangement, the optical coupler is a planar/fold mirror 530 arranged to fold or turn the optical path of light to achieve the required optical coupling from the first replicator to the second replicator. As shown in FIG. 5B, the mirror 530 is arranged to receive light-comprising a one-dimensional array of replicas extending in the first dimension-from the output port/reflective-transmissive surface 524a of the first replicator/waveguide 520. The mirror 530 is tilted so as to redirect the received light onto an optical path to an input port in the (fully) reflective surface of second replicator 540 at an angle to provide waveguiding and replica formation, along its length in the second dimension. It will be appreciated that the mirror 530 is one example of an optical element that can redirect the light in the manner shown, and that one or more other elements may be used instead, to perform this task.

In the illustrated arrangement, the (partially) reflective-transmissive surface 524a of the first replicator 520 is adjacent the input port of the first replicator/waveguide 520 that receives input beam 522 at an angle to provide waveguiding and replica formation, along its length in the first dimension. Thus, the input port of first replicator/waveguide 520 is positioned at an input end thereof at the same surface as the reflective-transmissive surface 524a. The skilled reader will understand that the input port of the first replicator/waveguide 520 may be at any other suitable position.

Accordingly, the arrangement of FIG. 5B enables the first replicator 520 and the mirror 530 to be provided as part of a first relatively thin layer in a plane in the first and third dimensions (illustrated as an x-z plane). In particular, the size or “height” of a first planar layer-in which the first replicator 520 is located-in the second dimension (illustrated as the y dimension) is reduced. The mirror 530 is configured to direct the light away from a first layer/plane, in which the first replicator 520 is located (i.e. the “first planar layer”), and direct it towards a second layer/plane, located above and substantially parallel to the first layer/plane, in which the second replicator 540 is located (i.e. a “second planar layer”). Thus, the overall size or “height” of the system-comprising the first and second replicators 520, 540 and the mirror 530 located in the stacked first and second planar layers in the first and third dimensions (illustrated as an x-z plane)—in the second dimension (illustrated as the y dimension) is compact. The skilled reader will understand that many variations of the arrangement of FIG. 5B for implementing the present disclosure are possible and contemplated.

### Reflection Suppression to Mitigate Glare

In operation, the transmission/exit surface (i.e. expanded exit pupil) of the second replicator 506 of the two-dimensional pupil expander of FIG. 5 forms an external surface or “output port”from which image light is transmitted through air to an eye-box area for viewing. Accordingly, the transmission surface may be exposed to sunlight from the environment in which the head-up display is used. Received sunlight may cause glare to the viewer, in particular due to reflections of sunlight associated with the pupil expander 506 and/or a turning film, if used in conjunction with the pupil expander 506. For example, glare may arise if rays of sunlight are directly reflected from the external transmission surface, or other surfaces of the pupil expander 506, at angles such that rays of sunlight follow an optical path directly to the viewing area/eye-box. This is described herein as “direct glare”. In another example, glare may arise if sunlight is coupled into the pupil expander 506 at angles such that rays of sunlight follow the same optical path within the pupil expander as rays of image light, or are otherwise reflected by surfaces thereof, in order to reach the viewing area/eye-box indirectly (e.g. via an optical combiner, such as a vehicle windscreen). This is described herein as “veiling glare”.

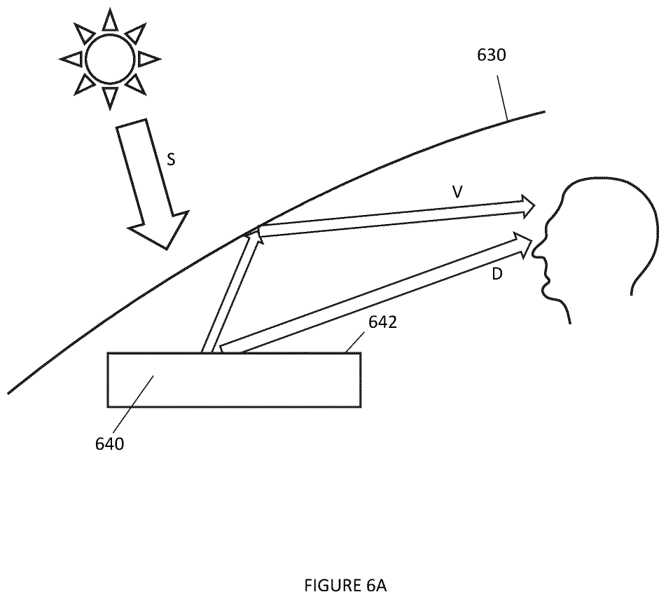

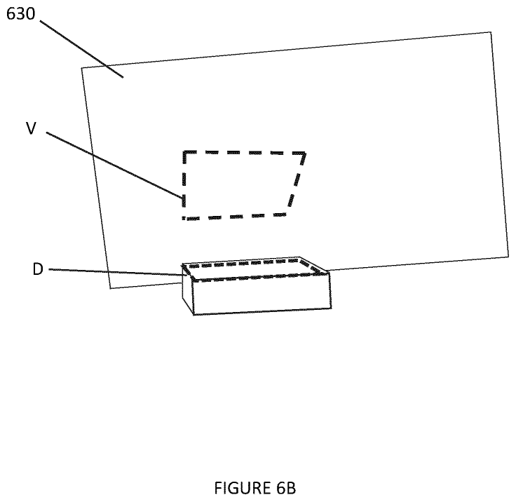

FIG. 6A shows the optical path of rays of sunlight S incident on the transmission/exit surface 642 of a (bulk optic) waveguide pupil expander 640 of a head-up display (HUD) in an automotive application. In particular, sunlight S at a relatively high elevation angle to the horizon is incident through a vehicle windscreen 630 onto the external transmission/exit surface 642 of the pupil expander 640. In the example, the transmission/exit surface 642 is located in a substantially horizontal plane in an aperture in the vehicle dashboard (not shown). Some sunlight rays D may be directly reflected from the pupil expander 640 (e.g. by one or more reflective layers thereof) towards the viewing area/eye-box and cause “direct glare”. Some other light rays V may be indirectly reflected from the pupil expander 640 (e.g. by one or more reflective layers thereof) towards the viewing area/eye box, via the windscreen 730 and cause “veiling glare”. Thus, light rays V may follow the same optical path(s) as image light output from the pupil expander 640. In either case, the glare arising from reflected sunlight may be harmful to the viewer/driver. FIG. 6B shows the view at the viewing area/eye-box indicating the areas of the windscreen and dashboard, from which the viewer/driver may receive sunlight glare. An area of direct glare D is seen at the exit/transmission surface in the vehicle dashboard (not shown) and an area of viewing glare V is seen at the vehicle windscreen. The skilled person will appreciate that the presence of glare from different positions within the illustrated areas D and V at a particular point in time may depend on the elevation angle of the sun and the configuration of the display system (both internally and in situ).

### Light Control Layer

Accordingly, the inventors propose using an optical component comprising a light control layer over the transmission surface of the second replicator/pupil expander, or more generally the output port of the HUD, to reduce the risk of glare to the viewer. An example light control layer for controlling the direction of received sunlight comprises a plurality of parallel louvres formed of a light absorbing, light attenuating or similar material. The inventors have recognized that a one-dimensional array of louvres, typically in the form of longitudinal rectangular-shaped louvre slats, may be used to control the direction and/or supress reflections of sunlight that may be incident on the transmission surface/output port of the HUD due to its upwardly facing/horizontal orientation in a vehicle dashboard adjacent the vehicle windscreen. The orientation (e.g., the side-wall angle(s)), pitch and geometry (e.g. length, width and thickness) of the louvres may be chosen to allow image light to be transmitted from the HUD at the desired range of angles necessary to reach the viewing area/eye-box.

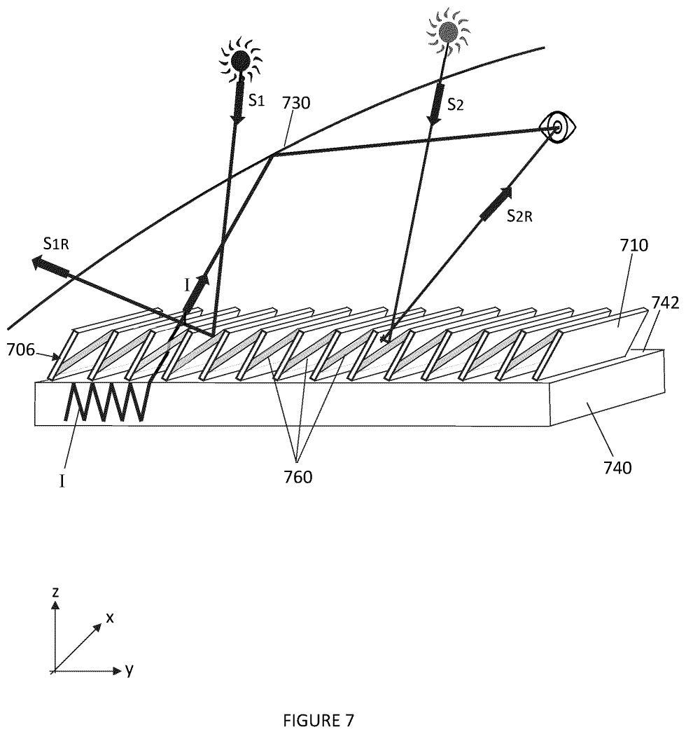

FIG. 7 shows a light control layer in the form of louvre structure 706 for reducing glare due to reflected sunlight. The louvre structure 706 comprises a plurality of parallel louvres/louvre slats 710 arranged in a one-dimensional array in a second dimension (illustrated as the y dimension). Thus, the length (long dimension) of the louvres/louvre slats 710 is parallel to a first dimension (illustrated as the x dimension), orthogonal to the second dimension, of the waveguide pupil expander 740. The louvre slats 710 comprise a light absorbing or light attenuating (e.g. light diffusing) material in order to block light rays incident thereon.

In the illustrated arrangement, the louvre structure 706 is disposed on a substantially planar transmission surface 742 forming the output port of a second replicator/waveguide pupil expander 740, which is arranged to internally reflect and replicate image light I to provide pupil expansion in the second dimension (illustrated as the y dimension). As shown in FIG. 7, in use, the transmission surface 742 of the waveguide pupil expander 740 is substantially horizontal and directly faces the windscreen 730 of a vehicle, which forms an optical combiner of the HUD display system. In the illustrated arrangement, the louvres/louvre slats 710 have a longitudinal rectilinear shape with parallel rectangular sidewalls. The (sidewalls of the) louvres/louvre slats 710 of the louvre structure 706 are arranged at an acute angle θ (i.e in a non-orthogonal plane) to the surface normal of the transmission surface. The angled orientation of the louvre slats 710 enables the light rays of the replicas of the image light I, which are formed and output by the waveguide pupil expander 740 at the transmission surface 742, to pass between the louvre slats 710 without deviation from the required optical path/s via the windscreen 730 to the viewing area/eye-box, as shown by the arrow for the rays of image light I. Thus, the angle θ is in the direction of the replicas of the image light I, and, thus, in the direction of pupil expansion by the waveguide pupil expander 740 (illustrated as from left to right in the y dimension). In other words, the louvre slats are inclined in the same direction as the propagation axes of the replicas of the image light, I, relative to the surface normal of the transmission surface 742.

In addition, optional transparent structures 760, having a similar longitudinal rectilinear shape to the louvre slats 710, are arranged at an angle between adjacent slats 710 (e.g. having a width (or cross-section) extending between near (e.g. substantially) the bottom of one louvre slat and near (e.g. substantially) the top of the adjacent louvre slat) so as to provide mechanical robustness to the louvre structure 706, and a protective cover of the transmission surface 742. An inclination angle of the transparent structures is therefore different to (e.g. greater than) the inclination angle θ of the louvre slats. The transparent structures 760 are configured (e.g. shaped) so that the light rays I of the image light output by the waveguide pupil expander 740 do not deviate from the required optical path (e.g. due to refraction at the surfaces thereof).

In the illustrated arrangement, the light control layer formed by the louvre structure 706 may reduce sunlight glare to a viewer at the viewing area/eye-box. In particular, FIG. 7 shows rays of sunlight S₁ from the sun at a first elevation angle (with respect to the horizon) that pass though the windscreen 730 and are incident on the louvre structure 706. Some of these rays (not shown) of sunlight S₁ may be incident directly on the louvre slats 710 where the light is absorbed or attenuated without reaching the transmission surface 742. In addition, some of these rays (shown) of sunlight S₁ may be incident on the transparent structures 760 between the louvre slats 710 as shown. Owing to the configuration and orientation of the transparent structures 760, these rays of sunlight S₁ may be specularly reflected by one or more surfaces of the transparent structure 760 in a direction back through the windscreen 730, and thus reflected rays of sunlight S_{1R} are directed on an optical path away from the viewing area/eye-box as shown by the arrow. FIG. 7 further shows rays of sunlight S₂ from the sun at a second elevation angle, which is higher/greater than the first elevation angle, that also pass though the windscreen 730 and are incident on the louvre structure 706. Owing to the configuration and orientation of the transparent structures 760, the rays of sunlight S₂ may be specularly reflected by one or more surfaces of the transparent structure 760 in a direction onto one of the louvres 710, and thus absorbed or attenuated. This blocks/reduces the intensity of reflected rays of sunlight S_{2R} which may be directed towards the viewing area/eye-box as shown by the arrow.

### Sunlight Reflections Within the Optical Component Below the Light Control Layer

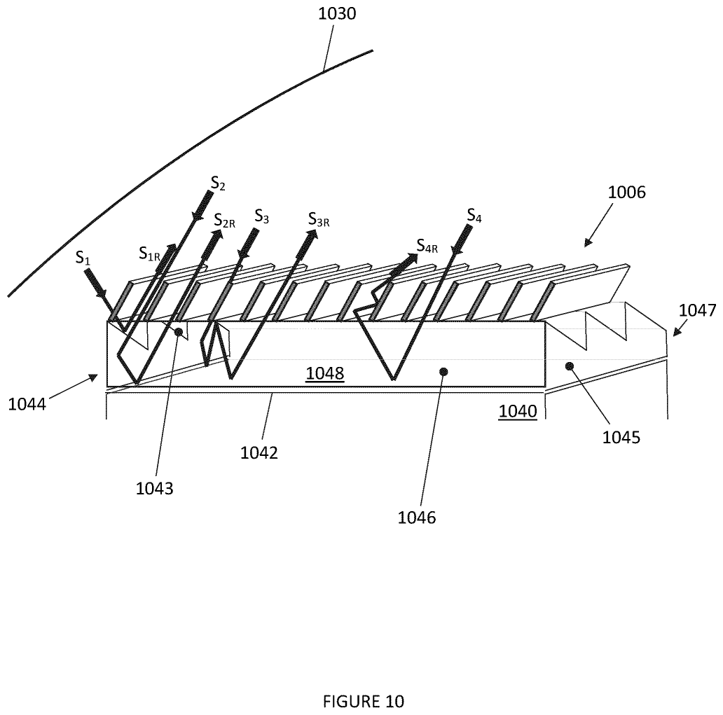

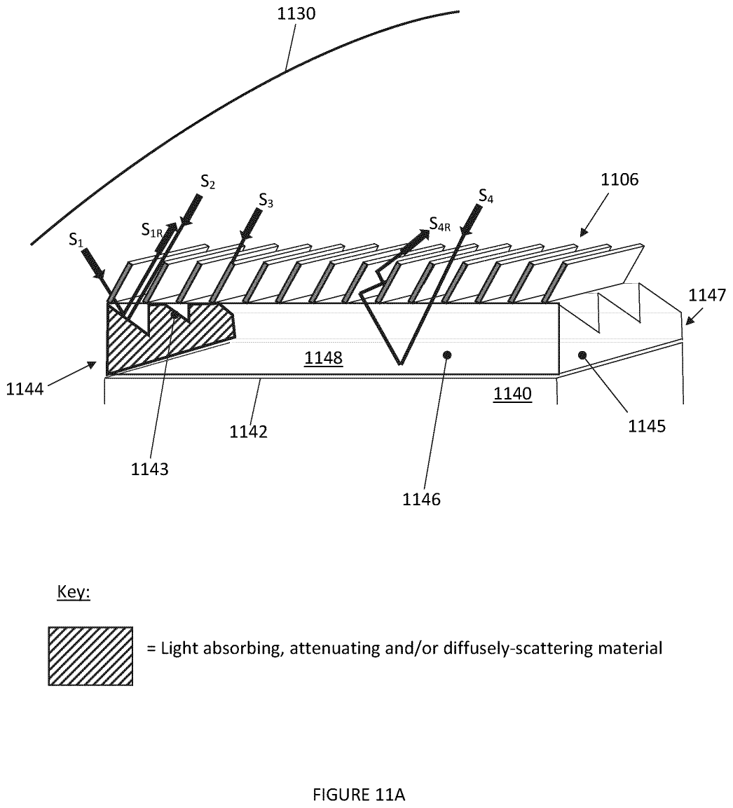

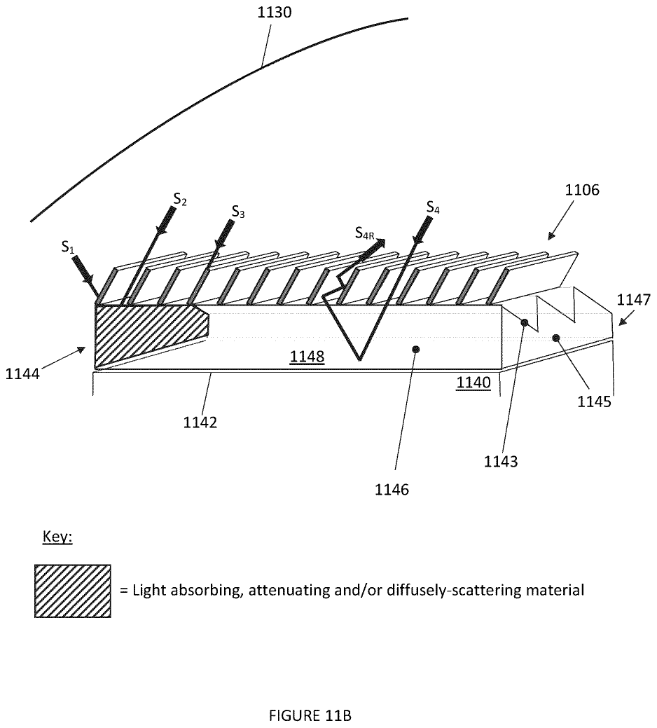

The presence of a light control layer comprising a louvre structure disposed over a sunlight-receiving first major surface of an optical component, such as the transmission surface of a waveguide pupil expander as described above, is able to supress or reduce many of the possible sunlight reflections that may be directed on an optical path towards the viewing area of the display system and cause glare. Nevertheless, the inventors have found that there still remain some possible sources of reflections of sunlight, which may originate as a result of internal reflections within the optical component below the louvre structure, that may be able to exit through the louvre structure and be directed along an optical path to the viewing area and cause glare. FIG. 10 shows example rays of sunlight reflections from these sources.

Referring to FIG. 10, a first potential source of sunlight reflections is from a first type of sunlight S₁, which is incident at a position relatively close to a first end 1044 of the waveguide pupil expander 1040—where the direction of pupil expansion is from the first end 1044 to a second end 1045 thereof. First sunlight S₁ is received (through windscreen 1030) in a direction such that rays are incident on an external minor surface (i.e. external edge face) at the first end 1044 of the waveguide pupil expander 1040. In the illustrated arrangement, the waveguide pupil expander 1040 includes a light turning layer 1046 comprising an array of turning prisms (referred to herein as a “light turning prism layer”) disposed over the external major transmission surface 1042 thereof. The louvre structure comprises a one-dimensional array of air-spaced louvres/louvre slats, as described herein, which are arranged over (the top of inclined surfaces of) the prisms of the light turning prism layer 1046. The illustrated ray of first sunlight S₁ is incident on the external minor surface/edge face at the first end 1044 of the light turning prism layer 1048. As shown in FIG. 10, the ray of first sunlight S₁ is reflected from an inclined surface 1043 of a prism of the light turning prism layer 1048 and the reflected first sunlight ray S_{1R} is directed on an optical path between a pair of louvres of the louvre structure 1006 in a direction towards the viewing area, as shown by the arrow.

A second potential source of sunlight reflections is from second and third types of sunlight S₂ and S₃, which are respectively received (through windscreen 1030) in a direction such that rays are incident on the louvre structure 1006 and transmitted into the light turning prism layer 1048 of the waveguide pupil expander 1040. In particular, an illustrated ray of second sunlight S₂ is incident on the louvre structure 1006 at substantially the same angle as the orientation angle θ of the louvres/louvre slats. Thus, the ray of second sunlight S₂ passes between a pair of louvres (optionally through a transparent structure between louvres/louvre slats (not shown)) into the light turning prism layer 1048. The illustrated ray of second sunlight S₂ undergoes several internal reflections within the light turning prism layer 1048. In particular, the ray of second sunlight S₂ is firstly reflected from an internal minor surface/edge face at the first end 1044 of the light turning prism layer 1048 and secondly from the transmission surface 1042 of the waveguide pupil expander 1040 at its interface with the light turning prism layer 1046. As a result, the illustrated reflected second sunlight ray S_{2R} is directed on an optical path between a pair of louvres of the louvre structure 1006 in a direction towards the viewing area as shown by the arrow. An illustrated ray of third sunlight S₃ is also incident on the louvre structure 1006 at substantially the same angle as the orientation angle θ of the louvres. Thus, the ray of third sunlight S₃ passes between a pair of louvres (optionally through a transparent structure between louvres/louvre slats (not shown)) into the light turning layer 1046. The illustrated ray of third sunlight S₃ undergoes several internal reflections within the light turning prism layer 1048, which are different from the internal reflections of the ray of second sunlight S₂. In particular, the ray of third sunlight S₃ is firstly reflected from an internal minor surface/edge face at the first end 1044 of the light turning prism layer 1048, secondly from the transmission surface 1042 of the waveguide pupil expander 1040 at its interface with the light turning prism layer 1046, thirdly from an inclined surface 1043 of a prism back into the light turning prism layer 1048, and fourthly, from the transmission surface 1042 of the waveguide pupil expander 1040 at its interface between the light turning prism layer 1046. As a result, the illustrated reflected third sunlight ray S_{2R} is also directed on an optical path between a pair of louvres/louvre slats of the louvre structure 1006 in a direction towards the viewing area as shown by the arrow. In the cases of both the rays of second and third sunlight S₂, S₃, the angle of incidence on the internal minor surface/edge face at the first end 1044 of the light turning prism layer 1048 may be above the critical angle, leading to total internal reflection. Thus, the intensity of reflections illustrated by the rays of second and third sunlight S₂, S₃ may be high and cause glare at the viewing area.

FIG. 10 also shows how the louvre structure 1006 supresses reflections from a fourth type of sunlight S₄, which—in this example—is incident on the louvre structure 1006 at a position further way from the first end 1044 of the waveguide pupil expander 1040, and is transmitted through the transmission surface 1042 into the light turning prism layer 1048 of the waveguide pupil expander 1040. In particular, an illustrated ray of fourth sunlight S₄ is incident on the louvre structure 1000 at substantially the same angle as the orientation angle θ of the louvres/louvre slats. Thus, the ray of fourth sunlight S₄ passes between a pair of louvres/louvre slats (optionally through a transparent structure between louvres (not shown)) into the light turning prism layer 1048. Since the ray of fourth sunlight S₄ is incident on the louvre structure 1006 further away from the first end 1044 than the rays of second and sunlight S₂ and S₃, it undergoes only a single reflection from the transmission surface 1042 of the waveguide pupil expander 1040 at its interface with the light turning prism layer 1046 before exiting the optical component between a pair of louvres/louvres slats. However, in consequence of the louvre arrangement, the ray of fourth sunlight S₄ is directed on an optical path towards an angled sidewall of one of the pair of louvres/louvre slays, where it is absorbed or attenuated. In addition, any reflection from the sidewall of the one of the pair of louvres/louvre slats is reflected onto the opposite sidewall of the other of the pair of louvres/louvre slats, thereby further absorbing or attenuating the light. In consequence, reflections of the fourth sunlight S₄ are suppressed and not directed on an optical path towards the viewing area so as to cause glare.

As the skilled person will appreciate, the above examples of first, second, third and fourth types of sunlight are dependent upon the elevation angle of the sun relative to the horizon (or, conversely, the azimuth angle relative to the vertical) and other factors relating of the optical component in situ (e.g. the shape of the windscreen 1030 and the position and orientation angle of the transmission surface 1042 thereof). Thus, the presence of these types of sunlight will depend on the time of day, the orientation of the optical component relative to the sun and so on.

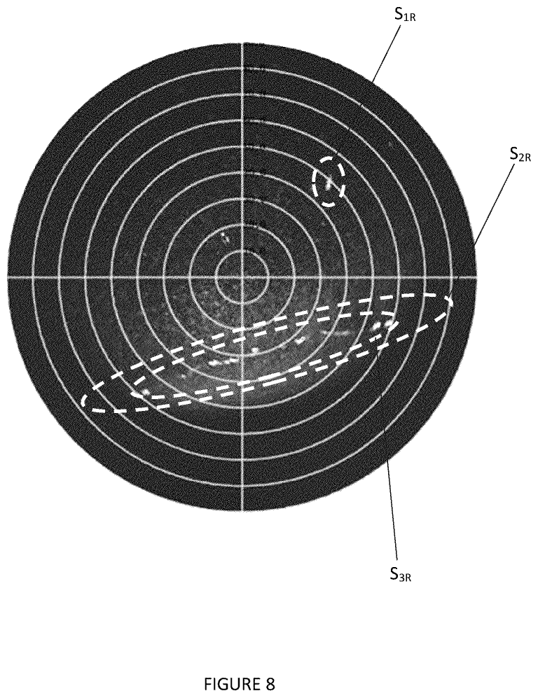

FIG. 8 is a polar plot for different sun elevation angles, showing simulations of sunlight glare, at the centre of the viewing area of an automotive head-up display comprising a waveguide pupil expander in accordance with a comparative example. In accordance with convention, the origin (at the centre) of the polar plot corresponds to the sun at a zenith angle of 0° (i.e. 90° elevation angle relative to the horizon) and so vertical/directly overhead of the HUD, and the concentric circles represent reducing elevation angles (depicted at 10° intervals from a zenith angle of 10° to a zenith angle of 90° at the outer circle) at respective positions relative to the HUD. As the skilled person will appreciate, glare arising at the centre of the viewing area (i.e. eye-box) is reasonably representative of the entire eye-box. In the comparative example, simulations were based on an example waveguide pupil expander comprising a light turning prism layer and a louvre structure, as shown FIG. 10.

FIG. 8 shows elliptical areas surrounding the polar positions of the sun that were found to give rise to intense sunlight glare (e.g. above a threshold intensity) at the centre of the viewing area. The first, second and third elliptical areas correspond to reflections S_{1R}, S_{2R} and S_{3R} of the first, second and third types of sunlight S₁, S₂ and S₃, as described above with reference to FIG. 10. The simulations show that the intensity of the sunlight glare from these types of reflections within the corresponding elliptical areas S_{1R}, S_{2R} and S_{3R} may cause difficulties for a viewer, such as driver of a vehicle or in other similar applications, in which the direction and elevation angle of received sunlight dynamically changes with time.

### Mitigations Techniques for Sunlight Reflections Below the Light Control Layer

The inventors propose herein measures to address the problem of glare due to reflections of sunlight resulting from internal reflections within the optical component beneath a louvre structure, as described above. The skilled person will appreciate that these measures may be equally applied to optical components of display systems that do not comprise a louvre structure.

FIG. 11A shows a first embodiment. In accordance with the first embodiment, a minor surface of the optical component is arranged to absorb, attenuate and/or diffusely scatter/reflect light. In the illustrated embodiment, the optical component is a light turning prism layer 1148. FIG. 11A also shows the light turning prism layer 1148 is disposed on a waveguide pupil expander 1140, and a louvre structure 1106 is disposed on the light turning prism layer 1148, as described above with reference to FIG. 10. The minor surface of the optical component is parallel to the longitudinal dimension of the louvre slats. In particular, the light absorbing/attenuating/diffusely reflecting minor surface is an edge face of the light turning prism layer 1148 at the first end 1144 thereof (wherein the direction of pupil expansion is from the first end 1144 to a second end 1145). For example, the minor surface of the prisms at the first end 1144 of the light turning prism layer 1148 may be coated with a light absorbing, diffusely reflecting/scattering and/or attenuating coating. In an example, the coating may be a black paint applied to the external minor surface/edge face. In another example, the minor surface of the prisms at the first end 1144 of the light turning prism layer 1148 may be treated (e.g. etched) or provided with a coating or film that diffusely reflects/scatters light incident thereon. In examples in which the minor surface diffusely reflects or scatters incident light, the reflected light is also attenuated. The inventors propose a hemispherical diffuse reflection of less than 10%, optionally less than 4%. This may be achieved by a combination of a light absorbing coating, such as black paint, and treating the surface to provide a surface roughness (e.g. by etching) to diffusely reflect incident light. The skilled person will appreciate that a variety of alternatives to a coating on, or a treatment of, the minor surface/edge face are possible including arrangements comprising any other type of material, element or component that absorbs, attenuates and/or diffusely reflects/scatters light incident thereon.

By providing a light absorbing, attenuating or diffusely reflecting/scattering minor surface/edge face at the first end 1144 of the prisms of the light turning prism layer 1148, rays corresponding to second and third sunlight S₂ and S₃ are supressed. In particular, as shown in FIG. 11A, rays of first and second sunlight S₂ and S₃ that are incident on the louvre structure 1106 between pairs of louvres are directly or indirectly incident on the internal minor surface/edge face at the first end 1144, and, in consequence, are absorbed, attenuated and/or diffusely reflected as shown by the arrows. Thus, when the rays of and second and third sunlight S₂ and S₃ are incident on the minor surface/edge face at the first end 1144 of the prisms of the light turning prism layer 1148 at angles above the critical angle, the intensity of the totally internally reflected light is reduced. In the case that the light is diffusely reflected/scattered, a reduced proportion of light of the rays of second and third sunlight S₂ and S₃ follows an optical path to the viewing area and so the risk of glare to the viewer is reduced.

FIG. 11B shows a second embodiment, generally equivalent to the first embodiment. However, in accordance with the second embodiment, the light /sorbing/attenuating/ diffusely reflecting minor surface is extended above the prisms (e.g. in an area between the prisms and the louvre structure) of the light turning prism layer 1148 at the first end 1144. In the case that the inclined surfaces of adjacent prisms of the light turning prism layer 1148 are separated by air, this may be achieved by providing a separate opaque border adjacent the (external) minor surface/edge face at the first end 1144 of the optical component. Such an opaque border may be included either as an alternative or in addition to providing a surface coating (or equivalent) as in the first embodiment of FIG. 11A, as described further below. For example, the border may comprise a sheet material having light absorbing, diffuse reflecting/scattering and/or attenuating properties or may comprise a sheet material comprising a coating or film having light absorbing, diffuse reflecting/scattering and/or attenuating properties.

By extending the light absorbing, attenuating or diffusely reflecting/scattering minor surface/edge face to include an area above the prisms of the light turning prism layer 1148, rays corresponding to first sunlight S1 are supressed. In particular, as shown in FIG. 11B, rays of first sunlight S1 that are incident directly on the external minor surface/edge face of the light turning prism layer 1148 at an inclined surface 1143 (at the top) of the prism(s) are absorbed, attenuated or scattered as shown by the arrow.

In the embodiments of FIGS. 11A and 11B, the optical component is a light turning prism layer 1048 as disclosed herein. As the skilled person will appreciate, in other embodiments, the optical component may comprise a waveguide pupil expander 1140 (e.g. without a light turning layer thereon). In this case, the minor surface/edge face at the first end of the waveguide pupil expander 1140 will be arranged to be light absorbing, attenuating or diffusely reflecting/scattering. In still further embodiments, the optical component may comprise a combination of a waveguide pupil expander 1140 and a light turning layer 1148 thereon. In this case, the minor surface/edge faces at the first end of both the waveguide pupil expander 1150 and the light turning prism layer 1148 will be arranged to be light absorbing, attenuating or diffusely reflecting/scattering. Such embodiments may be appropriate for applications, in which features of the optical component, such as the louvre structure 1106, allows rays of sunlight to be incident, either directly or indirectly, on the minor surface/edge face of the waveguide pupil expander 1140 at the first end 1144 thereof.

The skilled person will appreciate that, in some other arrangements, two or more minor surfaces forming respective edge faces of the optical component are arranged to absorb, attenuate or diffusely reflect/scatter light. For example, edge faces at the waveguide pupil expander of FIGS. 11A and 11B at both its first and second ends 1144, 1145 (parallel to the longitudinal dimensions of the louvres-illustrated as the x dimension in FIG. 7) and/or edge faces thereof at one or both of first and second sides 1146, 1147 (parallel to the dimension of the array of louvres-illustrated as the y dimension in FIG. 7) may be arranged to absorb, attenuate or diffusely scatter/reflect light as described herein.

In addition, or as an alternative, to the reflection suppression measures of the first or second embodiments, an opaque border may be provided around all the minor surfaces/edge faces of the optical component. In particular, an opaque box may be provided, surrounding the sides 1046, 1147 and ends 1144, 1145 of the waveguide pupil expander 1040, the light turning prism layer 1048 and louvre structure 1106 thereon. This opaque border may further prevent sunlight from entering the optical component through the minor surfaces/edge faces thereof, and may additionally supress internal reflections of sunlight incident on the minor surfaces/edge faces thereof. The opaque border may comprise a sheet material having light absorbing, diffuse reflecting/scattering and/or attenuating properties or may comprise a sheet material comprising a coating or film having light absorbing, diffuse reflecting/scattering and/or attenuating properties. For example, the opaque border may be treated (e.g. etched or roughened) so as to diffusely reflect/scatter and/or attenuate light incident thereon.

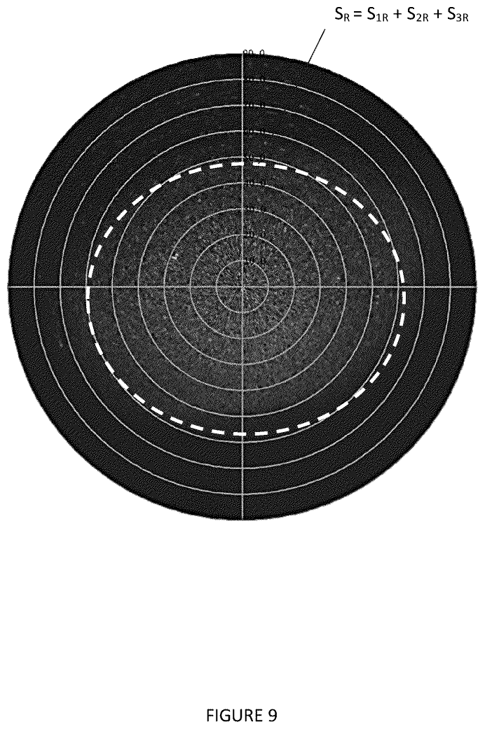

FIG. 9 is a polar plot, equivalent to FIG. 8, for different sun elevation angles, showing simulations of sunlight glare, at the centre of the viewing area of an automotive head-up display comprising a waveguide pupil expander in accordance with the second embodiment of FIG. 11B.

FIG. 9 shows a central generally circular area within which polar positions of the sun were found to give rise to sunlight reflections SR at the centre of the viewing area. In particular, sunlight reflections are diffuse, low intensity reflections (e.g. below a threshold for intensity) at all polar positions within the generally circular area depicted. Accordingly, the first, second and third types of reflections described above are diffuse and indistinguishable from each other at the viewing area. Accordingly, the simulations surprisingly found that sunlight glare at the viewing area is considerably reduced as a result of the measures and techniques described herein.

### Combiner Shape Compensation

An advantage of projecting a hologram to the eye-box is that optical compensation can be encoded in the hologram (see, for example, European patent 2936252 incorporated herein by herein). The present disclosure is compatible with holograms that compensate for the complex curvature of an optical combiner used as part of the projection system. In some embodiments, the optical combiner is the windscreen of a vehicle. Full details of this approach are provided in European patent 2936252 and are not repeated here because the detailed features of those systems and methods are not essential to the new teaching of this disclosure herein and are merely exemplary of configurations that benefit from the teachings of the present disclosure.

### Control Device

The present disclosure is also compatible with optical configurations that include a control device (e.g. light shuttering device) to control the delivery of light from a light channelling hologram to the viewer. The holographic projector may further comprise a control device arranged to control the delivery of angular channels to the eye-box position. British patent application 2108456.1, filed 14 Jun. 2021 and incorporated herein by reference, discloses the at least one waveguide pupil expander and control device. The reader will understand from at least this prior disclosure that the optical configuration of the control device is fundamentally based upon the eye-box position of the user and is compatible with any hologram calculation method that achieves the light channeling described herein. It may be said that the control device is a light shuttering or aperturing device. The light shuttering device may comprise a 1D array of apertures or windows, wherein each aperture or window independently switchable between a light transmissive and a light non-transmissive state in order to control the delivery of hologram light channels, and their replicas, to the eye-box. Each aperture or window may comprise a plurality of liquid crystal cells or pixels.

### Additional Features

The methods and processes described herein may be embodied on a computer-readable medium. The term “computer-readable medium” includes a medium arranged to store data temporarily or permanently such as random-access memory (RAM), read-only memory (ROM), buffer memory, flash memory, and cache memory. The term “computer-readable medium” shall also be taken to include any medium, or combination of multiple media, that is capable of storing instructions for execution by a machine such that the instructions, when executed by one or more processors, cause the machine to perform any one or more of the methodologies described herein, in whole or in part.

The term “computer-readable medium” also encompasses cloud-based storage systems. The term “computer-readable medium” includes, but is not limited to, one or more tangible and non-transitory data repositories (e.g., data volumes) in the example form of a solid-state memory chip, an optical disc, a magnetic disc, or any suitable combination thereof. In some example embodiments, the instructions for execution may be communicated by a carrier medium. Examples of such a carrier medium include a transient medium (e.g., a propagating signal that communicates instructions).

It will be apparent to those skilled in the art that various modifications and variations can be made without departing from the scope of the appended claims. The present disclosure covers all modifications and variations within the scope of the appended claims and their equivalents.

1. A head-up display system comprising:
an optical component having first and second major surfaces and one or more minor surfaces, wherein each minor surface forms an edge face of the optical component, wherein one or more of the first and second major surfaces are reflective; and
a light control layer disposed over the first major surface of the optical component, wherein the light control layer comprises a louvre structure comprising an array of louvres arranged to supress reflections of sunlight received on an optical path to the first major surface;
wherein at least one edge face of the optical component is arranged to diffusely reflect or scatter of light incident thereon.

2. A display system as claimed in claim 1 wherein the at least one edge face of the optical component is arranged to attenuate light incident thereon.

3. A display system as claimed in claim 2 wherein the at least one edge face of the optical component comprises:
a material, element or component that attenuates light, and/or
a material, element or component that diffusely reflects or scatters light.

4. A display system as claimed in claim 2 wherein the at least one edge face of the optical component is coated with a light attenuating coating, such as an opaque coating.

5. A display system as claimed in claim 2 wherein the at least one edge face of the optical component is treated, such as by etching, so as to attenuate or diffusely reflect light incident thereon.

6. A display system as claimed in claim 2 wherein the at least one edge face of the optical component is arranged to diffusely reflect/scatter light with a hemispherical diffuse reflection of less that 10%

7. A display system as claimed in claim 1 wherein the at least one edge face of the optical component is arranged to absorb light incident thereon.

8. A display system as claimed in claim 7 wherein the at least one edge face of the optical component comprises a light absorbing material, optionally wherein the at least one edge face is coated with a light absorbing coating.

9. A display system as claimed in claim 1 wherein the first major surface of the optical component comprises an exit surface for the output of image light of the display system to a viewing area.

10. A display system as claimed in claim 9 wherein the optical component comprises a light turning element for controlling the direction of the output image light from the exit surface.

11. A display system as claimed in claim 10 wherein the light turning element comprises a first major surface and one or more minor surfaces each forming an edge face thereof, wherein at least one edge face of the light turning element is arranged to suppress specular reflection of light incident thereon.

12. A display system as claimed in claim 11 wherein the first major surface of the light turning element is an interface with the exit surface of the optical component.

13. A display system as claimed in claim 10 wherein the light turning element is a light turning film, such as a film comprising an array of prisms having inclined surfaces opposite the exit surface of the optical component.

14. A display system as claimed in claim 10 wherein the at least one edge face of the light turning element is arranged to absorb light incident thereon or to attenuate or diffusely reflect/scatter light incident thereon.

15. A display system as claimed in claim 1 comprising an opaque border or box surrounding the one or more minor surfaces of the optical component.

16. A display system as claimed in claim 1 wherein the optical component comprises a waveguide pupil expander, and the first and second major surfaces are opposed/parallel reflective surfaces arranged to provide internal reflection and waveguiding of image light therebetween, optionally wherein the first major surface comprises a partially reflective-partially transmissive surface forming an exit surface of the waveguide pupil expander.

17. A display system as claimed in claim 16 wherein the at least one edge face arranged to suppress specular reflection of light incident thereon comprises an edge face at a first end of the waveguide pupil expander, or an edge face of a light turning element on the exit surface of the waveguide pupil expander adjacent the first end thereof, wherein pupil expansion is from the first end to a second end of the waveguide pupil expander.

18. A waveguide pupil expander for the display system of claim 16.

19. A method for suppressing reflections of sunlight in a head-up display, the method comprising:
providing an optical component having a first second major surface, and second major surface, and one or more minor surfaces, wherein each minor surface of the one or more minor surfaces forms an edge face of the optical component, wherein one or more of the first and second major surfaces are reflective, and wherein a light control layer is disposed over the first major surface of the optical component;
suppressing reflections of sunlight received on an optical path to the first major surface with a louvre structure comprising an array of louvres comprised in the light control layer;
diffusely reflecting or scattering light incident on at least one edge face of the optical component; and
transmitting light from the optical structure to an eye-box at a desired angle determined by an orientation of the array of louvres.
